(19) United States
(12) Patent Application Publication
(10) Pub. No.: US 2023/0344051 A1
(43) Pub. Date: Oct. 26, 2023

(54) BATTERY MODULE

(71) Applicant: Robert Bosch GmbH, Stuttgart (DE)

(72) Inventors: Markus Schmitt, Tamm (DE); Ralph Glemser, Brackenheim (DE)

(21) Appl. No.: 18/302,246

(22) Filed: Apr. 18, 2023

(30) Foreign Application Priority Data
Apr. 21, 2022 (DE) 10 2022 203 908.4

(51) Int. Cl. H01M 50/204; H01M 10/42; H01M 10/653; H01M 50/296; H01M 50/574; H01M 10/6557

(52) U.S. Cl. CPC H01M 50/204; H01M 10/425; H01M 10/653; H01M 50/296; H01M 50/574; H01M 10/6557

(57) ABSTRACT

A battery module having a plurality of battery cells, which are each electroconductively connected serially and/or in parallel to each other, and having a switching device, which comprises a first connector and a second connector, wherein the first connector is electroconductively connected to a voltage tap of a terminally arranged battery cell, and wherein the second connector is electroconductively connected to a voltage tap of the battery module, and having a temperature control element configured such that a temperature control fluid flows through it and which is also thermoconductively connected to the plurality of battery cells as well as the switching device, wherein the temperature control element comprises a first region, which is arranged immediately adjacent the plurality of battery cells and comprises a second region, which is arranged immediately adjacent the switching device.

### BACKGROUND OF THE INVENTION

The invention is based on a battery module comprising a plurality of battery cells, which are electroconductively connected serially and/or in parallel to each other, a switching device, which comprises a first connector and a second connector, wherein the first connector is electroconductively connected to a voltage tap of a terminally arranged one of the battery cells, and wherein the second connector is electroconductively connected to a voltage tap of the battery module, and a temperature control element configured such that a temperature control fluid flows through the temperature control element and which is also thermoconductively connected to the plurality of battery cells and the switching device.

A battery module comprises a plurality of individual battery cells, each comprising a positive voltage tap and a negative voltage tap, in which case the respective voltage taps are electroconductively connected to one another and thereby able to be connected to the battery module in an electroconductive serial and/or parallel connection of the plurality of battery cells. In particular, the battery cells can each comprise a first voltage tap, in particular a positive voltage tap, and a second voltage tap, in particular a negative voltage tap, which taps are electroconductively connected to one another by means of cell connectors so that an electroconductive serial and/or parallel circuitry is formed.

Battery modules are themselves in turn interconnected into batteries or entire battery systems.

Due to chemical conversion processes, the interiors of lithium-ion battery cells or lithium polymer battery cells heat up, primarily during rapid energy delivery or absorption in battery systems.

The more powerful a battery system is, the greater its heating, thus resulting in the need for an efficient active thermal management system. The temperature of the plurality of battery cells can thereby be controlled, i.e., cooled and/or heated.

The majority of battery cells will be cooled.

The prior art includes, e.g., publications DE 10 2021 200 040 and DE 10 2018 220 937, as well as DE 10 2020 206 338 and DE 10 2020 206 339.

### SUMMARY OF THE INVENTION

The advantage of a battery module having the features of the disclosure is a design providing reliable heat dissipation in a plurality of battery cells of the battery module and a switching device of the battery module.

In particular, it is possible to reliably connect a switching device connected to a housing of the battery module, e.g., in a thermoconductive manner, to a temperature control element acting as a thermal sink, and also to form a minimal length for a thermal path between the switching device and the temperature control element so that optimum temperature control of the switching device can be provided. In addition, a direct thermal coupling between the plurality of battery cells and the fuse element can additionally be minimized.

According to the present invention, a battery module with a plurality of battery cells is provided for this purpose. In this context, the battery cells are in particular each designed as lithium-ion battery cells. Furthermore, the battery cells are each electroconductively connected serially and/or in parallel to each other. The battery module also comprises a switching device comprising a first connector and a second connector. In this case, the first connector is electroconductively connected to a voltage tap of a terminally arranged battery cell, and the second connector is electroconductively connected to a voltage tap of the battery module. In addition, the battery module also comprises a temperature control element designed such that a temperature control fluid passes through it. In particular, the temperature control fluid is designed as a temperature control liquid. Furthermore, the temperature control element is thermoconductively connected to the plurality of battery cells as well as the switching device. According to the present invention, the temperature control element comprises a first region, which is arranged immediately adjacent the plurality of battery cells, and the temperature control element comprises a second region, which is arranged immediately adjacent the switching device.

Advantageous embodiments of and improvements to the apparatus are made possible by the measures explained in the dependent claims.

By virtue of arranging the first region immediately adjacent the plurality of battery cells, or rather arranging the second region immediately adjacent the switching device, a length for the thermal path between the plurality of battery cells, or rather between the switching device being cooled and the temperature control fluid, is reduced. It should further be noted at this point that the temperature control element, through which temperature control fluid can flow, is arranged below the plurality of battery cells and below the switching device during normal operation of the battery module. In particular, the first region is arranged below the plurality of battery cells, and the second region is arranged below the switching device.

Overall, an embodiment of the battery module according to the invention offers the advantage that optimum heat dissipation in the switching device can be designed at a minimal temperature difference between the temperature control fluid and the switching device. In particular, the second region completely covers the region where the switching device is arranged, so that the switching device is designed such that temperature control fluid flows beneath its entirety. A comparatively short thermal path can thereby be formed. In particular, the thermal energy can be immediately and directly conducted to the temperature control fluid without a heat conductor having a large area, e.g., in a direction transverse to the housing bottom, so that the plurality of battery cells and the switching device are thermally decoupled.

It should at this point be noted that a switching device is basically used to switch a circuit so that the latter is either open or closed. A battery module can in particular thereby be controlled such that a voltage tap of the battery module (e.g., the positive voltage tap of the battery module) can be provided in a voltage-free manner. Such switching devices thus carry the maximum current of the respective battery module. The switching device can in this case, e.g., be designed as a semiconductor switch, which is also referred to as a transistor, a power metal oxide semiconductor field-effect transistor (abbreviated as MOSFET), or an insulated gate bipolar transistor (abbreviated as IGBT). In addition, the switching device can in this case also be designed as a relay, for example, which is in principle a switch operated by an electrical current generally having two switch positions, and in which an electrical contact can be opened and closed, e.g., by an electromagnetic force.

According to a particularly preferred embodiment, the battery cells are each designed as prismatic battery cells. It should at this point be noted that prismatically formed battery cells each comprise a battery cell housing having a total of six side surfaces, which are arranged in pairs opposite each other and substantially parallel to each other. In addition, lateral surfaces arranged adjacent one another are arranged perpendicular to one another. The electrochemical components of the respective battery cell are housed in the interior of the battery cell housing. Typically, two voltage taps, in particular a positive voltage tap and a negative voltage tap, are arranged on a top side surface, which is referred to as the cover surface. The lower side surface opposite the upper side surface is referred to as the bottom surface.

Preferably, the switching device is arranged immediately adjacent a terminally arranged battery cell. As a result, it is possible to form a comparatively short connection between the switching device and the terminally arranged battery cell.

It is preferable for a thermal compensation material to in each case be arranged between the plurality of battery cells and the temperature control element and/or for a thermal compensation material to be arranged between the switching device and the temperature control element. A reliable thermal connection between the plurality of battery cells, or between the switching device and the temperature control element can thereby be provided. The thermal compensation material can be designed as what is referred to as a gap pad, a gap filler, or a thermoconductive adhesive.

Particularly preferably, the housing of the battery module forms the temperature control element. In particular, the regions which guide temperature control fluid are formed within the housing of the battery module. Overall, it is thus possible to omit an additional temperature control element, e.g. cooling plates. Such a housing of the battery module can, e.g., be designed as a die-cast housing.

It is further preferable in this case for a cover element to enclose a temperature control fluid intake formed by the housing of the battery module such that the temperature control element is formed. Overall, it is possible for temperature control fluid to be guided outside an interior space of the battery module so that, e.g., leakages do not lead to contact between the temperature control fluid and the plurality of battery cells. Preferably, the cover element is formed in a material-locking fashion, e.g. by means of friction stir welding, connected to the housing of the battery module, which is preferably designed as a diecast housing. A reliable connection formed in a fluid tight manner can thus be provided.

It is preferable for the housing of the battery module and/or the cover element to comprise and/or form a plurality of flow guide elements and/or a plurality of flow interference elements. In particular, a flow guide element or a flow interference element can be connected to the housing of the battery module and/or the cover element in a material-locking manner. It is thereby possible to optimize a thermoconductive surface within the temperature control element such that a particularly reliable thermal dissipation from the plurality of battery cells and the switching device to a temperature control fluid flowing through the temperature control element is made possible. It should at this point be noted that the flow guide elements are designed to guide the temperature control fluid within the temperature control element, and the flow interference elements are designed to increase turbulence in the temperature control fluid within the temperature control element and thereby improve thermal transfer. In addition, a thermoconductive surface is thereby also expanded.

On the one hand, it is thus possible to form an optimized flow guide and, on the other hand, to optimize a thermoconductive surface, while at the same time minimizing pressure loss.

According to a particularly advantageous embodiment of the invention, it is preferable for the first region to comprise a first type of flow interference elements and/or a first arrangement density of flow interference elements and for the second region to comprise a second type of flow interference elements and/or a second arrangement density of flow interference elements. Preferably, the first type and the second type and/or the first arrangement density and the second arrangement density are different. As a result, the first region, which is designed to control the temperature of the plurality of battery cells, and the second region, which is designed to control the temperature of the switching device, can be optimized independently and adapted to the relevant needs. In this case, the design of the flow interference elements includes, e.g., a geometric shape, a diameter, a slope, or a height of a respective flow interference element. The arrangement density describes the number of flow interference elements within a particular area. For example, the arrangement density can be influenced by a distance of individual flow interference elements from each other.

Of course, it is also possible for the first region and the second region to be identical in terms of the type of flow interference elements and the arrangement density of flow interference elements.

In addition, it is also preferable for the battery module to comprise an inlet which is designed for flow of the temperature control fluid into the temperature control element and for the battery module to comprise an outlet which is designed for flow of the temperature control fluid out of the temperature control element.

Advantageously, the flow guide within the temperature control element is designed to be U-shaped. In particular, temperature control fluid flows into the temperature control element through the inlet on one side of the housing and out of the temperature control element and through the outlet on the same side of the housing. In other words, the inlet and the outlet are arranged adjacent each other on a same side of the housing. In this case, it may be preferable to arrange a flow guide element inside the temperature control element such that a bypass flow between the inlet and the outlet is prevented.

It is also preferable for the switching device to be designed as a mechanical relay.

It should also be noted at this point that the plurality of battery cells, which are preferably designed in a prismatic manner, are preferably arranged adjacent one another in a longitudinal direction of the battery module. In an adjacent arrangement of the battery cells in a longitudinal direction of the battery module, the battery cells are arranged adjacent each other by way of their respective largest side surfaces, which are in particular each arranged perpendicular to the upper side surface and the lower side surface. It should at this point be noted that the longitudinal direction of the battery module is in this case accordingly arranged perpendicular to the largest side surfaces of the battery cells.

### BRIEF DESCRIPTION OF THE DRAWINGS

Exemplary embodiments of the invention are illustrated in the drawings and explained in greater detail in the subsequent description.

Shown are:

FIG. 1 a perspective view of a bottom of one embodiment of a battery module according to the invention,

FIG. 2 a perspective view of a detail of one embodiment of a battery module according to the invention,

FIG. 3a a plan view of the embodiment of the battery module according to the invention,

FIG. 3b a bottom view of the embodiment of the battery module according to the invention,

FIG. 4 a perspective view of a bottom view of the embodiment of the battery module according to the invention, and

FIG. 5 embodiments of possible flow interference elements.

### DETAILED DESCRIPTION

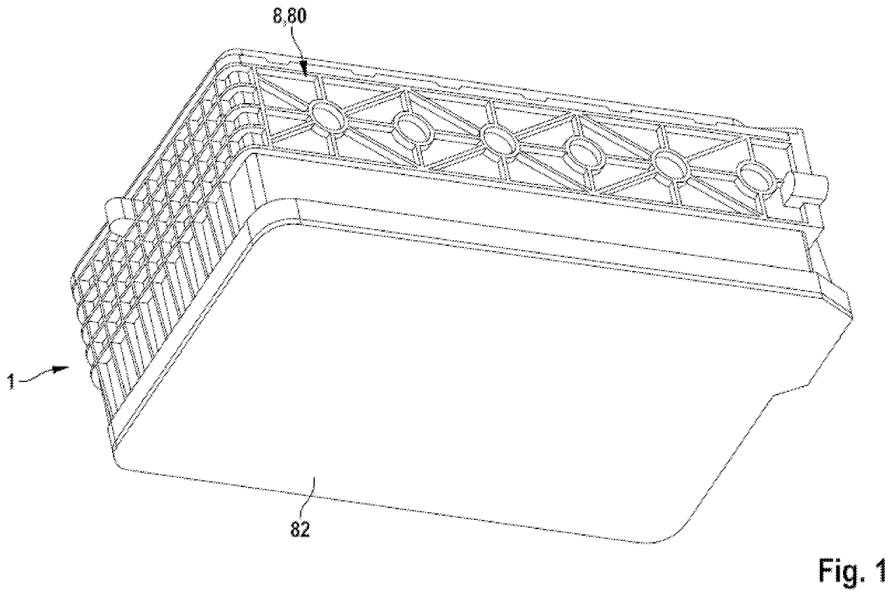

FIG. 1 shows a bottom of a battery module 1 according to the invention in a perspective view.

A housing 8 of the battery module 1 can in this case be recognized and is preferably designed as a diecast housing 80.

A cover element 82 can also be seen, which encloses a temperature control fluid intake 81 (not shown in FIG. 1), which is formed by the housing 8 of the battery module 1 such that a temperature control element 6 is formed.

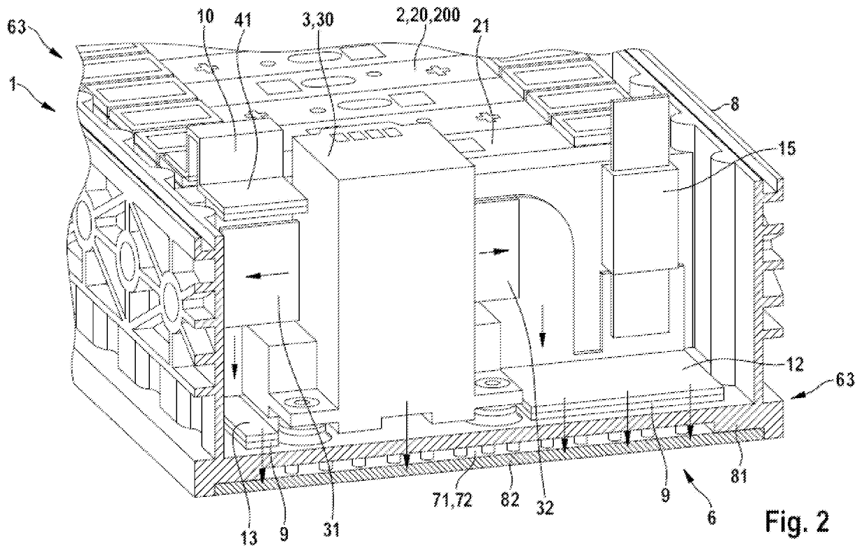

In a perspective view, FIG. 2 shows a detail of an embodiment of a battery module 1 according to the invention.

The battery module 1 comprises a plurality of battery cells 2, which are in particular each designed as lithium-ion battery cells 20. Further, the battery cells 2 are particularly designed as prismatic battery cells 200. The battery cells 2 can in this case be, e.g., electroconductively connected serially and/or in parallel to one another by means of cell connectors (not shown in FIG. 2).

The battery module 1 further comprises a switching device 3, which is in particular designed as a mechanical relay 30.

The switching device 3 is in this case arranged immediately adjacent a terminally arranged battery cell 21.

The switching device 3 in this case comprises a first connector 31, which is electroconductively connected to a voltage tap 41 of the terminally arranged battery cell 21. In particular, the battery module 1 comprises a first connection element 13 for this purpose. The first connecting element 13 is made of an electroconductive material and is in this case electroconductively connected to a terminally arranged cell connector 10 and to the first connector 31 such that the voltage tap 41 of the terminally arranged battery cell 21 is electroconductively connected to the first connector 31.

Furthermore, the switching device 3 comprises a second connector 32, which can be electrically connected to a voltage tap 51 of the battery module 1. In particular, the battery module 1 comprises a second connecting element 12. The second connecting element 12 is made of an electroconductive material and is in this case connected to the second connector 32 and can be connected to the voltage tap 51 of the battery module 1. Furthermore, it is shown in FIG. 1 that a securing element 15 can be arranged between the second connecting element 12 and the voltage tap 51 of the battery module 1.

Furthermore, the first connecting element 13 and the second connecting element 12 are thermoconductively connected to the housing 8. In particular, the connection is designed to be immediately adjacent the temperature control element 6.

Also visible in FIG. 2 is the temperature control element 6, which is designed such that a temperature control fluid 71, in particular a temperature control liquid 72, passes through it. The temperature control element 6 is in this case also thermoconductively connected to the plurality of battery cells 2 as well as the switching device 3.

Looking at FIG. 2, it can further be seen that a thermal compensation material 9 is arranged between the plurality of battery cells 2 and the temperature element 6, as well as between the switching device 3 and the temperature element 6.

It should at this point be noted that the housing 8 of the battery module 1 forms the temperature control element 6.

In particular, the housing 8 of the battery module 1 forms a temperature fluid intake 81, which is enclosed by the cover element 82 such that the temperature control element 6 is formed.

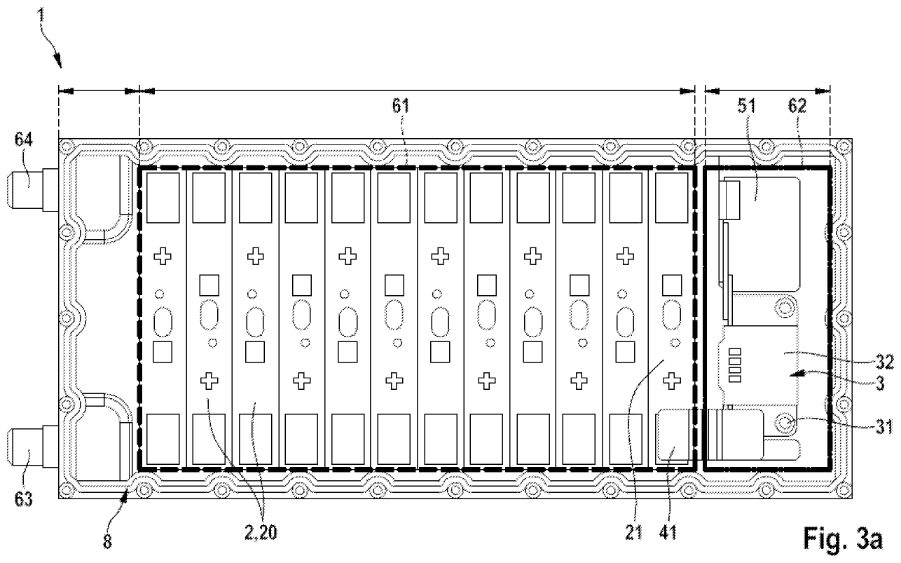

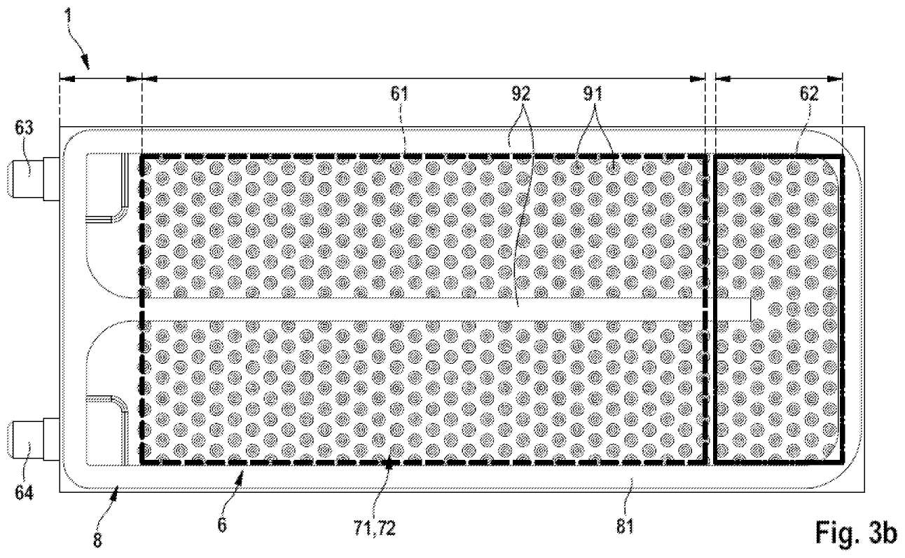

FIG. 3a shows an overhead view of the embodiment of the battery module 1 according to the invention, and FIG. 3b shows a bottom view of the embodiment of the battery module 1 according to the invention. FIGS. 3a and 3b are both described together in the following.

It can be seen that the temperature control element 6 comprises a first region 61, which is arranged immediately adjacent the plurality of battery cells 2 and that the temperature control element 6 comprises a second region 62, which is arranged immediately adjacent the switching device 3.

It can also be seen that the battery module 1 comprises an inlet 63, which is designed for flow of the temperature control fluid 71 into the temperature control element 6 and that the battery module 1 comprises an outlet 64, which is designed for flow of the temperature control fluid 71 out of the temperature control element 6.

It can in particular be seen in FIG. 3b that the housing 8 of the battery module forms or comprises a plurality of flow guide elements 91 and a plurality of flow interference elements 92.

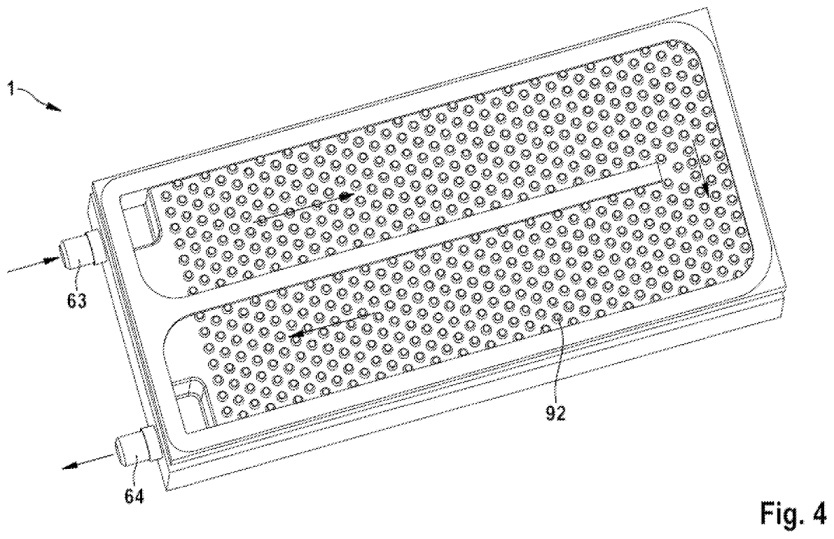

FIG. 4 shows a sectional view of an embodiment of a battery module 1 according to the invention.

It can be seen that a U-shaped flow guide is formed in this case.

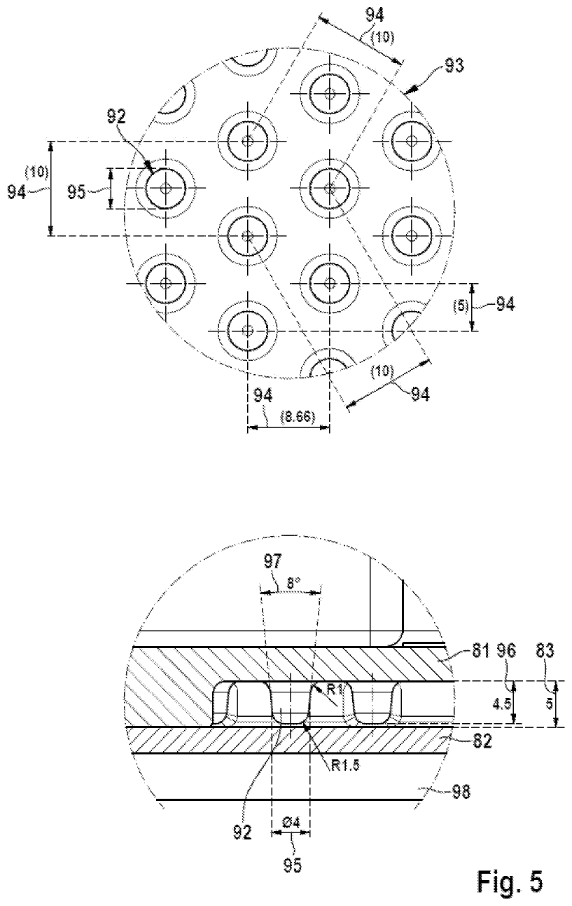

FIG. 5 shows embodiments of possible flow interference elements 92.

In the upper illustration an arrangement density of the plurality of flow interference elements 92 should also be illustrated in particular. In this context, the array density describes the number of flow interference elements 92, e.g., within a particular region 93.

It can also be seen in this case that the flow interference elements 92 are arranged at a distance 94 from each other. By way of varying the distance 94, the arrangement density can also be changed. In particular, it should at this point be noted that the distance 94 can both describe a distance immediately between two flow interference elements 92, and it can also describe a distance between two rows in which the flow interference elements 94 are arranged.

The lower illustration of FIG. 5 shows the type of the plurality of flow interference elements 92 in particular.

In particular, the lower illustration also shows the intake 81 in the housing 8 of the battery module 1 and the cover element 82.

It should at this point be noted that the design of the intake 81 and the cover element 82 enables determination of the height 83 of a flow channel of the temperature control element 6.

The design of the flow interference element 92 is in particular characterized by its geometrical shape, and in this case by, e.g., a diameter 95, a height 96, an opening angle 97, and/or a slope 98.

1. A battery module comprising
a plurality of battery cells (2), which are electroconductively connected serially and/or in parallel to each other,
a switching device (3), which comprises a first connector (31) and a second connector (32), wherein the first connector (31) is electroconductively connected to a voltage tap (41) of a terminally arranged one of the battery cells (21), and wherein the second connector (32) is electroconductively connected to a voltage tap (51) of the battery module (1), and
a temperature control element (6) configured such that a temperature control fluid (71) flows through the temperature control element (6) and which is also thermoconductively connected to the plurality of battery cells (2) and the switching device (3), characterized in that the temperature control element (6) comprises a first region (61), which is arranged immediately adjacent the plurality of battery cells (2), and comprises a second region (62), which is arranged immediately adjacent the switching device (3).

2. The battery module according to claim 1, characterized in that the switching device (3) is arranged immediately adjacent the terminally arranged one of the battery cells (21).

3. The battery module according to claim 1, characterized in that a thermal compensation material (9) is arranged between the plurality of battery cells (2) and the temperature control element (6) and/or between the switching device (3) and the temperature control element (6).

4. The battery module according to claim 1, characterized in that a housing (8) of the battery module (1) forms the temperature control element (6).

5. The battery module according to claim 4, characterized in that a cover element (82) encloses a temperature control fluid intake (81) formed by the housing (8) of the battery module (1) such that the temperature control element (6) is formed.

6. The battery module according to claim 5, characterized in that the housing (8) of the battery module (1) and/or the cover element (82) forms and/or comprises a plurality of flow guide elements (91) and/or a plurality of flow interference elements (92).

7. The battery module according to claim 6, wherein the first region (61) comprises a first type of flow interference elements (92) and/or a first arrangement density of flow interference elements (92), and wherein the second region (62) comprises a second type of flow interference elements (92) and/or a second arrangement density of flow interference elements (92).

8. The battery module according to claim 1, characterized in that the battery module (1) comprises an inlet (63) configured for an inflow of temperature control fluid (71), and the battery module (1) comprises an outlet (64) configured for an outflow of temperature control fluid (71).

9. The battery module according to claim 1, comprising a U-shaped flow guide.

10. The battery module according to claim 1, characterized in that the switching device (3) is configured as a mechanical relay (30).

11. The battery module according to claim 1, characterized in that a thermal compensation material (9) is arranged between the plurality of battery cells (2) and the temperature control element (6).

12. The battery module according to claim 1, characterized in that a thermal compensation material (9) is arranged between the switching device (3) and the temperature control element (6).

13. The battery module according to claim 1, characterized in that a housing (8) of the battery module (1) forms the temperature control element (6), wherein a cover element (82) encloses a temperature control fluid intake (81) formed by the housing (8) of the battery module (1) such that the temperature control element (6) is formed, and wherein the housing (8) of the battery module (1) and/or the cover element (82) forms and/or comprises a plurality of flow guide elements (91).

14. The battery module according to claim 1, characterized in that a housing (8) of the battery module (1) forms the temperature control element (6), wherein a cover element (82) encloses a temperature control fluid intake (81) formed by the housing (8) of the battery module (1) such that the temperature control element (6) is formed, and wherein the housing (8) of the battery module (1) and/or the cover element (82) forms and/or comprises a plurality of flow interference elements (92).

15. The battery module according to claim 14, wherein the first region (61) comprises a first type of flow interference elements (92) and wherein the second region (62) comprises a second type of flow interference elements (92).

16. The battery module according to claim 14, wherein the first region (61) comprises a first arrangement density of flow interference elements (92), and wherein the second region (62) comprises a second arrangement density of flow interference elements (92).

17. A battery module comprising
a plurality of lithium-ion battery cells (20), which are electroconductively connected serially and/or in parallel to each other,
a switching device (3), which comprises a first connector (31) and a second connector (32), wherein the first connector (31) is electroconductively connected to a voltage tap (41) of a terminally arranged one of the battery cells (21), and wherein the second connector (32) is electroconductively connected to a voltage tap (51) of the battery module (1), and
a temperature control element (6) configured such that a temperature control liquid (72) flows through the temperature control element (6) and which is also thermoconductively connected to the plurality of battery cells (2) and the switching device (3), characterized in that the temperature control element (6) comprises a first region (61), which is arranged immediately adjacent the plurality of battery cells (2), and comprises a second region (62), which is arranged immediately adjacent the switching device (3).

18. The battery module according to claim 17, characterized in that the switching device (3) is arranged immediately adjacent the terminally arranged one of the battery cells (21).

19. The battery module according to claim 18, characterized in that a thermal compensation material (9) is arranged between the plurality of battery cells (2) and the temperature control element (6) and/or between the switching device (3) and the temperature control element (6).

20. The battery module according to claim 19, characterized in that a housing (8) of the battery module (1) forms the temperature control element (6).

21. The battery module according to claim 20, characterized in that a cover element (82) encloses a temperature control fluid intake (81) formed by the housing (8) of the battery module (1) such that the temperature control element (6) is formed.
